(19) United States
(12) Patent Application Publication
(10) Pub. No.: US 2006/0068699 A1
(43) Pub. Date: Mar. 30, 2006

(54) Apparatus and method for receiving satellite DMB

(75) Inventors: Il-Ho Lee, Suwon-si (KR); Geum-Goo Han, Hwasung-si (KR); Dae-Suk Chung, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/228,779

(22) Filed: Sep. 16, 2005

(30) Foreign Application Priority Data
Sep. 16, 2004 (KR) 2004-0074066
Sep. 22, 2004 (KR) 2004-0075986

(51) Int. Cl. H04H 1/00

(52) U.S. Cl. 455/3.02; 455/422.1

(57) ABSTRACT

Disclosed is a satellite digital multimedia broadcasting (DMB) receiving apparatus and method for tracking the position of a satellite and displaying the satellite's position on a terminal. Additionally, in the presence of an obstacle, notifying a user of a reception impossible state caused by the obstacle, in order to enable the user to efficiently receive a satellite signal. The terminal for receiving digital broadcasting included a receiver for receiving a digital broadcasting signal, a geo-magnetic sensor for determining the position of the terminal, a controller for generating broadcasting reception state information using the azimuth of a satellite and the position of the terminal, and a display for displaying the broadcasting reception state information.

### PRIORITY

This application claims priority under 35 U.S.C. § 119(a) to an application entitled “Apparatus And Method For Receiving Satellite DMB (Digital Multimedia Broadcasting)” filed in the Korean Intellectual Property Office on Sep. 16, 2004 and assigned Serial No. 2004-74066, and to an application entitled “Digital Broadcasting Reception Terminal And Method For Displaying Receiving Power Of Digital Broadcasting Data And Direction Of Data” filed in the Korean Intellectual Property Office on Sep. 22, 2004 and assigned Serial No. 2004-75986, the contents of both of which are incorporated herein by reference.

### BACKGROUND OF THE INVENTION

1. Field of the Invention

The present invention relates generally to an apparatus and method for receiving satellite Digital Multimedia Broadcasting (DMB), and, more particularly, to a satellite DMB receiving apparatus and method for tracking the position of a satellite and displaying the satellite position on a terminal, and in addition, in the presence of an obstacle, notifying a user of a reception impossible state caused by the obstacle, in order to enable the user to efficiently receive a satellite signal.

2. Description of the Related Art

In contrast to analog broadcasting services, digital broadcasting services (also known as digital broadcasting) provides a better service having high image quality and higher voice quality. Accordingly, digital broadcasting services can be thought of as a substitute for analog broadcasting services. The development of digital broadcasting technologies and mobile communication technologies have recently led to interest in a digital broadcasting service that allows users to view digital broadcasting while moving. This mobile digital broadcasting service is known as a DMB service.

The DMB service enables viewers to enjoy diverse multimedia broadcasting contents while being mobile, using digital broadcasting-enabled terminals such as personal portable receivers and in-vehicle receivers equipped with an antenna.

In a satellite DMB service, a terrestrial broadcasting station transmits intended digital broadcasting data to a satellite and the satellite in turn transmits the digital broadcasting data to terminals on the ground, directly or through a repeater {called gap filler (GF)}. The GF sends the digital broadcasting data received from the satellite to terminals in an area where satellite signals are weak or otherwise inadequate for reception due to fading, attenuation, shadowing, noise, cancellation, shielding, etc. For example, a GF may be used to transmit digital broadcasting data in an area which is surrounded by tall buildings, which can cause shadowing of a satellite digital broadcasting data, or in an underground area in which a satellite digital broadcasting signal would be shielded.

In the case where the digital broadcasting terminal receives digital broadcasting data through the GF, the digital broadcasting terminal can receive the digital broadcasting data even in an area in which the satellite digital broadcasting is partially or fully attenuated or otherwise inadequate for reception (e.g., an underground subway, a tunnel, or a building's basement).

A block diagram illustrating a typical DMB system is shown in FIG. 1. A DMB center 20 transmits DMB data (e.g., pictures, voice, data, etc.) to a DMB satellite 10, after compression and modulation. The DMB satellite 10 re-transmits the broadcasting data to individual cells after amplification and frequency conversion. In general, each cell includes a plurality of GFs 30. A GF 30 provides the received broadcasting data to a digital broadcasting terminal 40. Digital broadcasting via the GF 30 rather than directly from the DMB satellite 10 ensures broadcasting quality which is adequate for reception by the digital broadcasting terminal 40 within the coverage area of the GF 30.

However, if the digital broadcasting terminal 40 moves out of the GF coverage area or does not belong to a specific cell, it receives satellite signals directly from the DMB satellite 10 for a continuous satellite DMB service. That is, in a GF-free area such as in mountainous or rural areas or in areas surrounded by large bodies of water, where there are no GFs, the digital broadcasting terminal 40 must receive signals directly from the DMB satellite 10 for the DMB service. However, because satellite signals become very weak at or below −90 dBm when the satellite signal nears the Earth's surface, it is impossible to receive the satellite signal without a satellite antenna as opposed to a conventional AM/FM antenna.

Even with a satellite antenna, a 2.6-GHz DMB signal from the DMB satellite 10 has a high linearity, which makes it very difficult to receive the reflected DMB signal. Therefore, the satellite antenna must be appropriately positioned to be within the line-of-sight of the DMB satellite 10, that is, to be within a valid DMB coverage area.

Moreover, even if the user of the digital broadcasting terminal 40 succeeds in tracking the direction of the DMB satellite 10 and thus initially acquires satellite signals, the user must monitor the satellite signal (the satellite antenna must be appropriately positioned) during roaming. Also, in the case where obstacles such as trees or buildings located in the line-of-sight path from the satellite block the satellite signal, the user must monitor the satellite signal to re-establish reception, which can increase power consumption and can inconvenience the user.

### SUMMARY OF THE INVENTION

An object of the present invention is to substantially solve at least the above problems and/or disadvantages and to provide at least the advantages below. Accordingly, an object of the present invention is to provide a digital broadcasting receiving terminal and method for so that a user who may be moving, can position the digital broadcasting receiving terminal to more readily receive satellite signals without interruption by displaying the position of a satellite on a terminal screen.

Another object of the present invention is to provide a digital broadcasting receiving terminal and method for, in the presence of an obstacle blocking a satellite signal despite detection of the direction of a satellite, notifying a user of the presence of the obstacle via a screen and thus enabling the user to receive the satellite signal by avoiding the obstacle.

A further object of the present invention is to provide a digital broadcasting receiving terminal and method for, in the case of receiving digital broadcasting data directly from a satellite, displaying a direction in which an antenna is to be moved for high reception sensitivity, and the received signal strength of the digital broadcasting data.

The above objects are achieved by providing a satellite digital multimedia broadcasting (DMB) receiving apparatus and method for tracking the position of a satellite and displaying the satellite position on a terminal, and in addition, in the presence of an obstacle, notifying a user of a reception-impossible state caused by the obstacle, in order to enable the user to efficiently receive a satellite signal.

According to one aspect of the present invention, in a terminal for receiving digital broadcasting, a receiver receives a digital broadcasting signal, a geo-magnetic sensor measures the position of the terminal, a controller generates broadcasting-reception-state information using the azimuth of a satellite and the position of the terminal, and a display displays the broadcasting reception state information.

The broadcasting reception information indicates the heading of an antenna in the terminal, the heading of the satellite, and a valid coverage area. The display displays the broadcasting reception state information graphically or in text.

A message notifying a user of the presence of an obstacle is displayed on the display, if the heading of the antenna falls within the valid coverage area and a current reception state value is equal to or less than a predetermined threshold.

According to another aspect of the present invention, in a method of displaying the heading of a satellite in a digital broadcasting terminal, it is determined whether a digital broadcasting signal has been received from the satellite or a gap filler, the position of the terminal is measured by a geo-magnetic sensor, broadcasting-reception-state information is generated using the azimuth of the satellite and the terminal position, and the broadcasting-reception-state information is displayed.

According to a further aspect of the present invention, in a method of displaying the heading of a satellite in a digital broadcasting terminal, it is determined whether a digital broadcasting signal has been received directly from the satellite, upon receipt of the digital broadcasting signal from the satellite. If the digital broadcasting signal was received directly from the satellite, the heading of the satellite is determined and displayed.

### BRIEF DESCRIPTION OF THE DRAWINGS

The above and other objects, features and advantages of the present invention will become more apparent from the following detailed description when taken in conjunction with the accompanying drawings, in which:

FIG. 1 is a block diagram illustrating a typical DMB system;

FIG. 2 is a block diagram illustrating a terminal for receiving satellite digital broadcasting according to an embodiment of the present invention;

FIG. 3 is a diagram illustrating the structure of a pilot channel according to an embodiment of the present invention;

FIG. 4 is a flowchart illustrating an operation for displaying broadcasting reception state information according to an embodiment of the present invention;

FIG. 5 is a flowchart illustrating an operation for processing broadcasting reception state information according to another embodiment of the present invention;

FIG. 6 is a diagram illustrating a screen display that provides a direction in which an antenna is to point and the received strength of digital broadcasting data, for DMB reception according to an embodiment of the present invention; and

FIGS. 7A, 7B and 7C are diagrams illustrating screen displays that provide broadcasting reception state information according to another embodiment of the present invention.

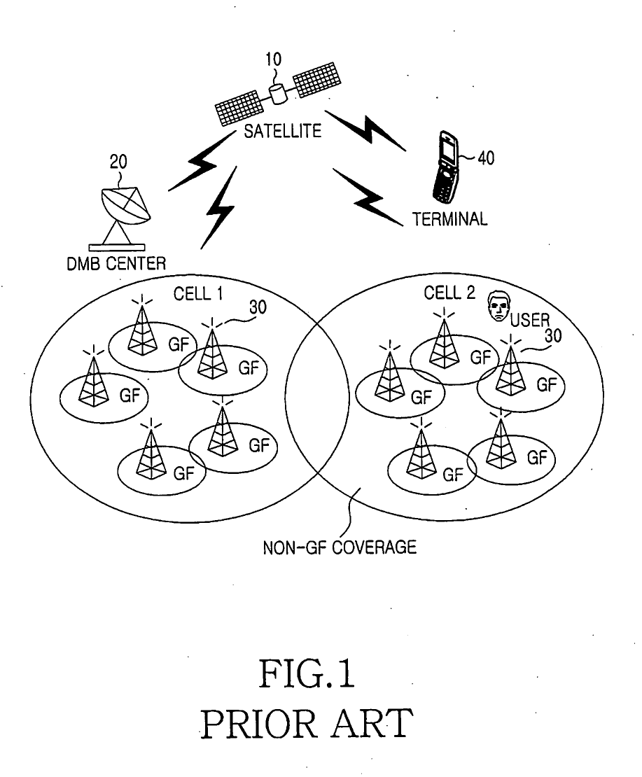

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention is intended to provide a method of tracking the position of a DMB satellite and displaying the satellite position on a terminal, for efficient reception of satellite signals in a satellite DMB system. It is to be appreciated herein that the present invention is applicable to all communications via a satellite in a geostationary Earth orbit as well as to a 2.6-GHz satellite DMB system.

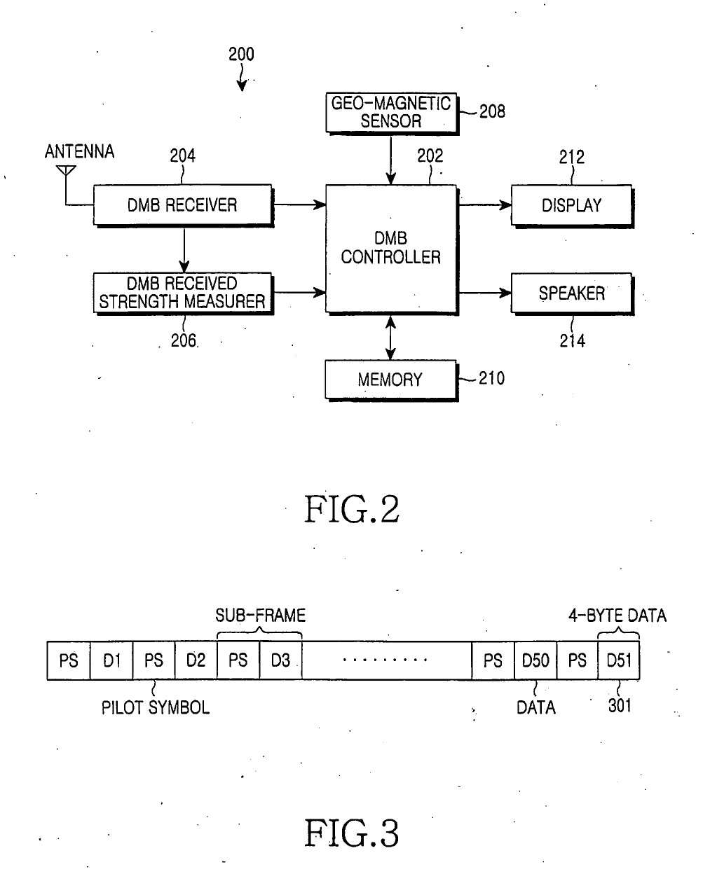

A block diagram illustrating a terminal for receiving satellite digital broadcasting according to an embodiment of the present invention is shown in FIG. 2. The terminal 200 includes a DMB controller 202, a DMB receiver 204, a DMB received strength measurer 206, a geo-magnetic sensor 208, a memory 210, a display 212 and a speaker 214.

The DMB controller 202 provides overall control to the terminal according to an embodiment of the present invention. Upon receipt of a digital broadcasting signal, the DMB controller 202 decompresses the digital broadcasting signal to original digital broadcasting data. In addition, the DMB controller 202 determines whether the digital broadcasting signal has been received directly from the DMB satellite 10 or via the GF 30. In the former case, the DMB controller 202 determines a satellite heading in which an antenna is to be moved to point in line-of-sight to the DMB satellite 10, and measures the received signal strength of the digital broadcasting signal.

The DMB receiver 204 receives the digital broadcasting signal from the DMB satellite 10 or the GF 30. The DMB received strength measurer 206 measures the received strength of the digital broadcasting signal.

The geo-magnetic sensor 208 senses the terminal's heading by measuring the Earth's magnetic field. In other words, the geo-magnetic sensor 208 measures an absolute angle corresponding to the heading of the terminal 200 by using the Earth's magnetic field.

The memory 210 stores the received digital broadcasting data. The display 212 displays images associated with the digital broadcasting data, the satellite heading, and the received signal strength under the control of the DMB controller 202. The satellite heading and the received signal strength are displayed separately from, or together with, the digital broadcasting data on the display 212. The speaker 214 outputs audio sounds corresponding to the digital broadcasting data.

The above configuration of the terminal for receiving satellite digital broadcasting is based on the assumption that the DMB controller 202 processes all data. Specifically, the DMB controller 202 calculates the azimuth angle of the terminal based on the terminal's position provided by the geo-magnetic sensor 208, and determines whether the terminal's 200 current position falls within a valid coverage area.

A diagram illustrating the structure of a pilot channel according to an embodiment of the present invention is shown in FIG. 3.

In accordance with the present invention, broadcasting reception is optimized according to broadcasting reception state information at the terminal.

The broadcasting reception state information includes the heading of a terminal's satellite DMB antenna, the heading of the DMB satellite, and a valid coverage area. The satellite heading and the valid coverage area are calculated using cell identification (ID) or the azimuth angle of the satellite received from the satellite. A satellite signal reception state (e.g., a “good” or “bad” satellite signal reception state) is determined depending on whether the heading of the satellite antenna falls within the valid coverage area.

Referring to FIG. 3, the cell ID or the satellite azimuth angle is delivered in a 4-byte D51 code (data subframe) 301 reserved in the system specification. While D51 is used to deliver a GF ID (transmitted from the satellite to the GF) at present, the GF ID can be replaced with the cell ID or the satellite azimuth angle according to the present invention. Cell ID or the satellite azimuth angle according to the present invention is transmitted from the satellite to the terminal directly or via GF.

In the present invention, some bits of the GF ID can be allocated to describe the cell ID or the satellite azimuth angle, rather than the current D51 code which is wholly dedicated to the cell ID or the satellite azimuth angle.

The DMB satellite is a geostationary satellite which is fixed over the equator. A satellite DMB signal arrives at or near the Earth's surface in the form of a plurality of beams, covering a plurality of cells. The coverage of each individual beam is limited to a local area. Therefore, when the satellite is seen from one cell, the heading of the satellite is almost identical across the cell and thus the satellite has almost the same azimuth angle in all locations within the same cell.

Therefore, it is possible for the user to determine the azimuth angle of the satellite using only a cell ID that identifies a serving cell. For example, the terminal 200 stores headings with respect to cell IDs in a database. When receiving a cell ID from the DMB satellite, the terminal 200 reads out a satellite azimuth angle corresponding to the cell ID.

As described above, the pilot channel delivers a cell ID or a satellite azimuth angle along with a satellite ID or a GF ID according to the present invention.

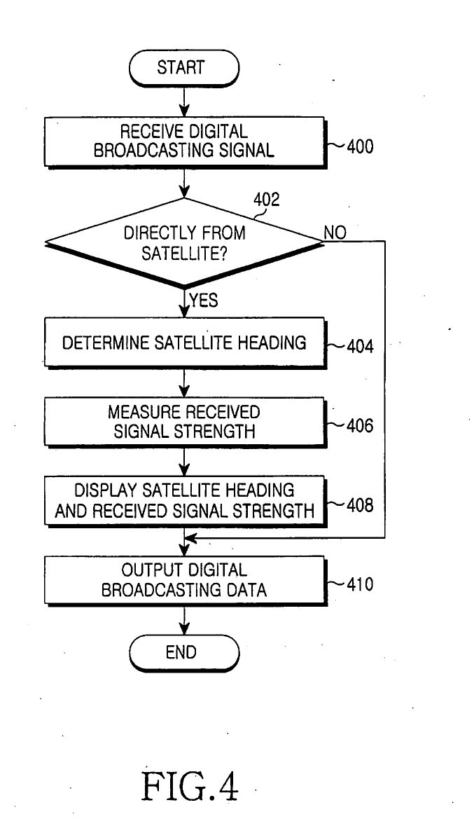

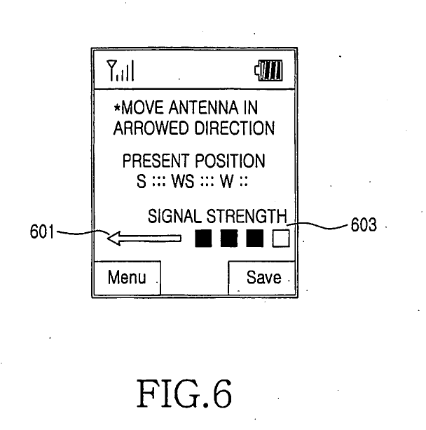

FIG. 4 is a flowchart illustrating an operation for displaying broadcasting reception state information according to an embodiment of the present invention, and FIG. 6 is a diagram illustrating a screen display that provides a satellite direction and the received strength of digital broadcasting data for DMB reception according to an embodiment of the present invention. The following description is made on the assumption that a digital broadcasting terminal is equipped with a satellite antenna for receiving digital broadcasting data directly from a satellite or via GF from a satellite.

Referring to FIGS. 4 and 6, the terminal 200 receives a digital broadcasting signal through the DMB receiver 204 in step 400 and determines whether the digital broadcasting signal is being transmitted directly from the satellite 10 or via the GF 30 in step 402. The determination can be made, for example, by reading a satellite ID or a GF ID set in a pilot channel signal illustrated in FIG. 3.

In the latter case, the terminal 40 outputs the digital broadcasting signal in step 410.

In the former case, the terminal 200 determines the heading of the satellite 10 at a current position in step 404. Specifically, the terminal 200 measures its position through the geo-magnetic sensor 208, and calculates a satellite heading in which the antenna is to be moved to point in line of sight to the DMB satellite 10 based on the position of the terminal 200 and the azimuth of the satellite 10. The azimuth of the satellite 10 can be pre-stored in the data base, or determined from a predetermined pilot channel frame received from the satellite 10.

In step 406, the terminal 200 measures the received strength of the digital broadcasting signal through the DMB received strength measurer 206.

In step 408, the terminal 200 displays the satellite heading and the received signal strength on the display 212. As stated above, the satellite heading is a heading in which it would be desirable to point the antenna, and the received signal strength is displayed to notify the user of a change in signal strength depending on an antenna direction. Referring to FIG. 6, reference numeral 601 denotes a satellite heading in which the terminal must be moved to be in line-of-sight with the DMB satellite 10, for better reception. Reference numeral 603 denotes the received signal strength. While not shown, if the received signal strength drops so that it is equal to or less than a predetermined threshold value, the satellite heading 601 and the received signal strength 603 can be displayed, overlaid on the display of broadcasting data.

In step 410, the terminal 200 outputs broadcasting data corresponding to the digital broadcasting signal. Specifically, the terminal 200 decompresses the digital broadcasting signal to original digital broadcasting data and outputs video data through the display 212 and audio data through the speaker 214.

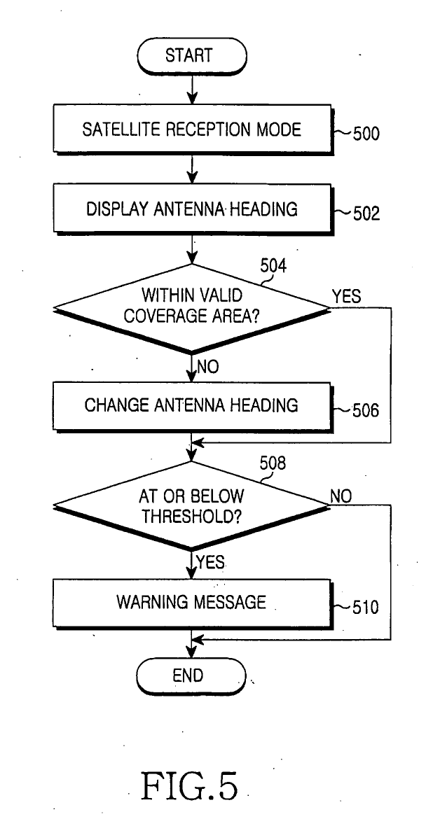

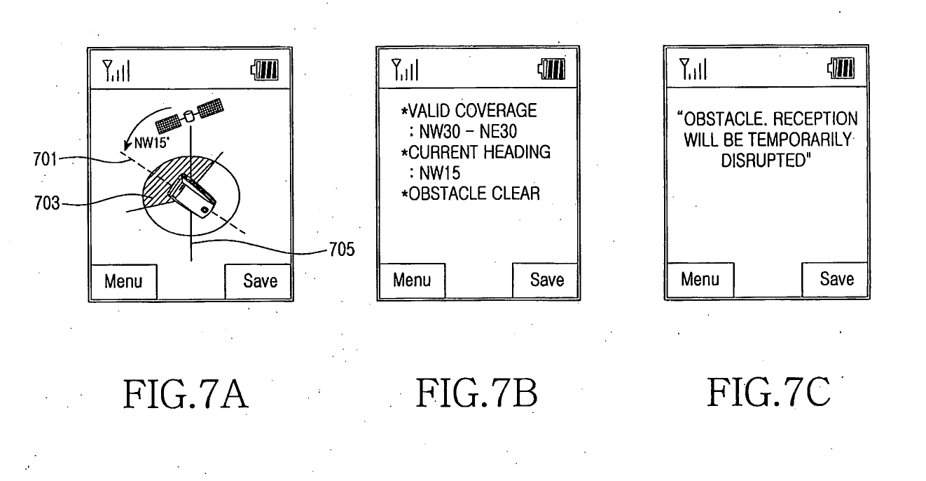

A flowchart illustrating an operation for processing broadcasting reception state information according to another embodiment of the present invention is shown in FIG. 5, and Diagrams illustrating screen displays that provide broadcasting reception state information according to another embodiment of the present invention are shown in FIGS. 7A, 7B and 7C.

This procedure is carried out in the case where a user moves out of a GF coverage area such as an urban area. It is assumed herein that the terminal is equipped with a detachable satellite antenna.

Referring to FIGS. 5, 7A, 7B and 7C, when the terminal 200 moves out of the coverage area of the GF 30, it transitions to a satellite reception mode in step 500. The mode transition can only occur when a satellite antenna is attached (or coupled) to the terminal 200. The terminal 200 detects the antenna installation using, for example, an interrupt (e.g., a controller interrupt, etc.) or polling routine.

In step 502, the terminal 200 calculates the heading of the satellite using a cell ID or a satellite azimuth angle set in the D51 code contained in the pilot channel and displays the satellite heading and the heading of the terminal measured by the geo-magnetic sensor 208 as broadcasting reception state information, as illustrated in FIGS. 7A and 7B. In alternative embodiments, the heading of the terminal can be determined using an accelerometer, triangulation, a global positioning system (gps) etc.

Referring to FIG. 7A, the terminal 200 detects a satellite heading 705 by sensing the direction of receiving a satellite signal. The heading 701 of the terminal 200, the satellite heading 705, and a valid coverage area 703 are graphically displayed. In FIG. 7B, the broadcasting reception state information is displayed in text. The valid coverage area ranges from Northwest 30° (NW30°) to Northeast 30° (NE30°) and the current antenna heading is Northwest 15° (NW15°).

In step 504, the terminal 200 determines whether the current antenna heading falls within the valid coverage area. If it does not, the user moves the terminal 40 so that the terminal 200 is in light-of-sight to the satellite 10 in step 506.

In step 508, the terminal 2000 determines whether a satellite signal is blocked by an obstacle. The terminal 200 considers that an obstacle exists if the antenna heading falls within the valid coverage area and a current reception state value (a current channel state) is equal to or less than a predetermined threshold value. The reception state value is determined using a bit error rate (BER) or a received signal strength indicator (RSSI).

If it is determined that the satellite's signal is being blocked by an obstacle, the terminal 200 warns of the presence of the obstacle in step 510. For example, the message can prompt the user to move his terminal due to the obstacle. In the case of an obstacle which temporarily blocks the satellite's signal, the user can just wait without doing anything until the obstacle no longer blocks the satellite's signal.

In view of the linearity of a satellite signal, the user may personally block the satellite's signal reception. The strength of the satellite signal becomes very weak at or below −90 dBm when it approaches the Earth's surface. Also, because the satellite signal is circular-polarized, it requires a helical antenna. Yet, the helical antenna is not viable option due to its large size.

While an external satellite antenna is required, the 2.6-GHz satellite signal cannot be received through reflection due to its high linearity. If the user stands with his body blocking the satellite signal or an obstacle blocks the satellite signal, the user may try to detect an appropriate antenna direction aimlessly or give up on receiving satellite reception completely.

In the above embodiment, the user can determine whether the antenna heading falls within the valid coverage area based on the displayed broadcasting-reception-state information, and point and/or move the antenna in a direction and/or move the antenna so that a satellite's signal reception can be optimized.

As described above, the present invention informs a terminal's user of a satellite's direction so that a user (who may be moving), can position the terminal with respect to more readily receive satellite signals without interruption, by displaying the position of a satellite on a terminal screen. Therefore, the user can receive conveniently receive satellite digital broadcasting signals. Also, in the presence of an obstacle, the user is notified of the obstacle's presence so that the user can wait, move the terminal, or avoid the obstacle.

Furthermore, the fast and effective satellite reception leads to the decrease of signal search time and power consumption.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A terminal for receiving digital broadcasting, comprising:
a receiver for receiving a digital broadcasting signal from a satellite;
a geo-magnetic sensor for determining the terminal's position;
a controller for generating broadcasting-reception-state information using the azimuth of the satellite and the terminal's position; and
a display for displaying the broadcasting-reception-state information.

2. The terminal of claim 1, wherein the broadcasting reception state information includes information indicating the heading of an antenna in the terminal, the heading of the satellite, and a valid coverage area.

3. The terminal of claim 1, wherein the controller generates the broadcasting-reception-state information when the digital broadcasting signal is received directly from the satellite.

4. The terminal of claim 1, wherein the display graphically or textually displays the broadcasting-reception-state information.

5. The terminal of claim 1, further comprising a signal strength measurer for measuring a received signal strength of the digital broadcasting signal, wherein the display displays the broadcasting-reception-state information and the received signal strength.

6. The terminal of claim 5, wherein the broadcasting-reception-state information indicates a heading in which the antenna is to be moved to point in line-of-sight to the satellite.

7. The terminal of claim 1, wherein the controller displays a message notifying of the presence of an obstacle on the display, if it is determined that the heading of the antenna falls within the valid coverage area and reception state value is less than or equal to a predetermined threshold value.

8. The terminal of claim 7, wherein the reception state value is determined based on a bit error rate (BER) or a received signal strength indicator (RSSI).

9. A method of displaying the heading of a satellite in a digital broadcasting terminal, comprising the steps of:
determining whether a digital broadcasting signal has been received from one of the satellite or a gap filler;
determining the position of the digital broadcasting terminal using a geo-magnetic sensor;
generating broadcasting reception state information using the satellite's azimuth and the terminal's position; and
displaying the broadcasting reception state information.

10. The method of claim 9, wherein the broadcasting reception state information includes information which indicates the heading the terminal's antenna, the heading of the satellite, and a valid coverage area.

11. The method of claim 10, wherein the valid coverage area is determined using a cell identification (ID) set in a pilot channel signal from the satellite.

12. The method of claim 9, wherein the displaying step comprises displaying the broadcasting reception state information when the received digital broadcasting signal is from the satellite.

13. The method of claim 9, wherein the broadcasting reception state information is displayed graphically textually.

14. The terminal of claim 9, further comprising the steps of:
comparing a current reception state value of the digital broadcasting signal with a predetermined threshold value, if a direction in which the digital broadcasting signal is received falls within a valid coverage area; and
alerting a user by displaying a warning message or outputting an audible alarm if the current reception state value is determined to be less than or equal to the predetermined threshold value.

15. The method of claim 14, wherein the reception state value is determined based on a bit error rate (BER) or a received signal strength indicator (RSSI).

16. A method of displaying the heading of a satellite in a digital broadcasting terminal, comprising the steps of:
determining whether a digital broadcasting signal has been received directly from the satellite, upon receipt of the digital broadcasting signal; and
determining the heading of the satellite and displaying the satellite heading on a display, if the digital broadcasting signal has been received from the satellite.

17. The method of claim 16, further comprising the step of measuring the received strength of the digital broadcasting signal and displaying the received signal strength on a display.

18. The method of claim 16, wherein the step of determining whether the digital broadcasting signal has been received directly from the satellite is determined using a satellite identification (ID) or a gap filler (GF) ID set in a pilot channel signal received from the satellite.

19. The method of claim 16, further comprising the step of, outputting digital broadcasting corresponding to the digital broadcasting signal, if the digital broadcasting signal has been received from a gap filler.

20. The method of claim 16, wherein the step of determining the heading of the satellite and displaying the satellite heading on the display comprises the steps of:
measuring the position of the digital broadcasting terminal;
determining a direction in which an antenna is to be moved to point in line-of-sight to the satellite using the position of the digital broadcasting terminal and the satellite's azimuth; and
displaying the determined direction on the display.

21. A terminal for receiving digital broadcasting, comprising:
a receiver for receiving a digital broadcasting signal from a satellite;
a geo-magnetic sensor for determining the terminal's position;
a controller for generating information relating to the satellite's heading using the satellite's azimuth angle and the terminal's position; and
a display for displaying the information indicating the satellite's heading.

22. The terminal of claim 21, wherein the controller generates the information relating to the satellite's heading when the digital broadcasting signal is received from the satellite.

23. A method of displaying the heading of a satellite in a digital broadcasting terminal, comprising the steps of:
determining whether a digital broadcasting signal has been received from the satellite;
measuring the position of the digital broadcasting terminal using a geo-magnetic sensor;
generating information relating to the satellite's heading using the satellite's azimuth and the digital broadcasting terminal's position; and
displaying the information relating to the satellite's heading.

24. The method of claim 23, wherein the displaying step comprises the step of displaying the information relating to the satellite's heading when the digital broadcasting signal is received from the satellite.
